(19) United States
(12) Patent Application Publication
(10) Pub. No.: US 2015/0121387 A1
(43) Pub. Date: Apr. 30, 2015

(54) TASK SCHEDULING METHOD FOR DISPATCHING TASKS BASED ON COMPUTING POWER OF DIFFERENT PROCESSOR CORES IN HETEROGENEOUS MULTI-CORE SYSTEM AND RELATED NON-TRANSITORY COMPUTER READABLE MEDIUM

(71) Applicant: MEDIATEK INC., Hsin-Chu (TW)

(72) Inventors: Ya-Ting Chang, Hsinchu City (TW); Jia-Ming Chen, Hsinchu County (TW); Yu-Ming Lin, Taipei City (TW); Yin Chen, Taipei City (TW); Hung-Lin Chou, Hsinchu County (TW); Yeh-Ji Chou, Taoyuan County (TW); Shou-Wen Ho, Hsinchu County (TW)

(21) Appl. No.: 14/480,646

(22) Filed: Sep. 9, 2014

Related U.S. Application Data
(60) Provisional application No. 61/897,362, filed on Oct. 30, 2013.

(51) Int. Cl. G06F 9/48

(52) U.S. Cl. CPC G06F 9/4893
USPC 718/103

(57) ABSTRACT

A task scheduling method is applied to a heterogeneous multi-core system. The heterogeneous multi-core system has at least one first processor core and at least one second processor core. The task scheduling method includes: referring to task priorities of tasks of the heterogeneous processor cores to identify at least one first task of the tasks that belongs to a first priority task group, wherein each first task belonging to the first priority task group has a task priority not lower than task priorities of other tasks not belonging to the first priority task group; and dispatching at least one of the at least one first task to at least one run queue of at least one of the at least one first processor core.

### CROSS REFERENCE TO RELATED APPLICATIONS

This application claims the benefit of U.S. provisional application No. 61/897,362, filed on Oct. 30, 2013 and incorporated herein by reference.

### BACKGROUND

The disclosed embodiments of the present invention relate to a task scheduling scheme, and more particularly, to a task scheduling method for dispatching tasks (e.g., real-time tasks) based on computing power of different processor cores in a heterogeneous multi-core system and a related non-transitory computer readable medium.

A multi-core system becomes popular nowadays due to increasing need of computing power. Hence, an operating system (OS) of the multi-core system may need to decide task scheduling for different processor cores to maintain good load balance and/or high system resource utilization. Regarding a heterogeneous multi-core system, it may have processor cores that are not identical to each other. For example, the heterogeneous multi-core system may include a first processor core and a second processor core, where the first processor core may have first processor architecture, and the second processor core may have second processor architecture that is different from the first processor architecture. Hence, if the same task is running on the first processor core and the second processor core, the processing time needed by the first processor core to finish execution of instructions of the task may be different from the processing time needed by the second processor core to finish execution of the same instructions of the task.

In general, the first processor core and the second processor core implemented in the heterogeneous multi-core system may have different computing power due to different processor architecture. For example, the first processor core may be a performance oriented processor core, while the second processor core may be a power-saving oriented processor core. Hence, the computing power/capability of the first processor core may be greater than that of the second processor core. However, a conventional task scheduling scheme is not aware of the different computing power of processor cores in the heterogeneous multi-core system. As a result, a task with the higher task priority may be dispatched to the second processor core with lower computing power for execution, and another task with the lower task priority may be dispatched to the first processor core with higher computing power for execution. This would lead to priority inversion. That is, the task with higher task priority may have longer latency and response time due to that execution of the task with lower task priority is accomplished/terminated before the execution of the task with higher task priority.

Thus, there is a need for an innovative task scheduling design which is capable of properly dispatching tasks to different processor cores of a heterogeneous multi-core system based on different computing power possessed by the processor cores.

### SUMMARY

In accordance with exemplary embodiments of the present invention, a task scheduling method for dispatching tasks (e.g., real-time tasks) based on computing power of different processor cores in a heterogeneous multi-core system and a related computer readable medium are proposed to solve the above-mentioned problem.

According to a first aspect of the present invention, an exemplary task scheduling method for a heterogeneous multi-core system is disclosed. The heterogeneous multi-core system includes at least one first processor core each having first computing power and at least one second processor core each having second computing power lower than the first computing power. The exemplary task scheduling method includes: referring to task priorities of tasks of the heterogeneous processor cores to identify at least one first task of the tasks that belongs to a first priority task group, wherein each first task belonging to the first priority task group has a task priority not lower than task priorities of other tasks not belonging to the first priority task group; and dispatching at least one of the at least one first task to at least one run queue of at least one of the at least one first processor core.

According to a second aspect of the present invention, another exemplary task scheduling method for a heterogeneous multi-core system is disclosed. The heterogeneous multi-core system includes at least one first processor core each having first computing power and at least one second processor core each having second computing power lower than the first computing power. The exemplary task scheduling method includes: referring to task priorities of tasks of the heterogeneous processor cores to identify at least one first task of the tasks that belongs to a first priority task group and identify at least one second task of the tasks that belongs to a second priority task group, wherein each first task belonging to the first priority task group has a task priority not lower than task priorities of other tasks not belonging to the first priority task group, each second task belonging to the second priority task group has a task priority not lower than task priorities of other tasks not belonging to the first priority task group and the second priority task group; and dispatching at least one of the at least one second task to at least one run queue of at least one of the at least one second processor core.

In addition, a non-transitory computer readable medium storing a task scheduling program code is also provided, wherein when executed by the heterogeneous multi-core system, the task scheduling program code causes the heterogeneous multi-core system to perform any of the aforementioned task scheduling methods.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a heterogeneous multi-core system according to an embodiment of the present invention.

FIG. 2 is a diagram illustrating a first task scheduling operation which dispatches one first task belonging to the first priority task group (e.g., a highest priority task group) to a run queue of one first processor core with higher computing power.

FIG. 3 is a diagram illustrating a second task scheduling operation which dispatches one second task belonging to the second priority task group (e.g., a next highest priority task group) to a run queue of one second processor core with lower computing power.

FIG. 4 is a diagram illustrating a third task scheduling operation which dispatches one second task belonging to the second priority task group (e.g., a next highest priority task group) to a run queue of one second processor core with lower computing power.

FIG. 5 is a diagram illustrating a fourth task scheduling operation which dispatches one first task belonging to the first priority task group (e.g., a highest priority task group) to a run queue of one first processor core with higher computing power.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

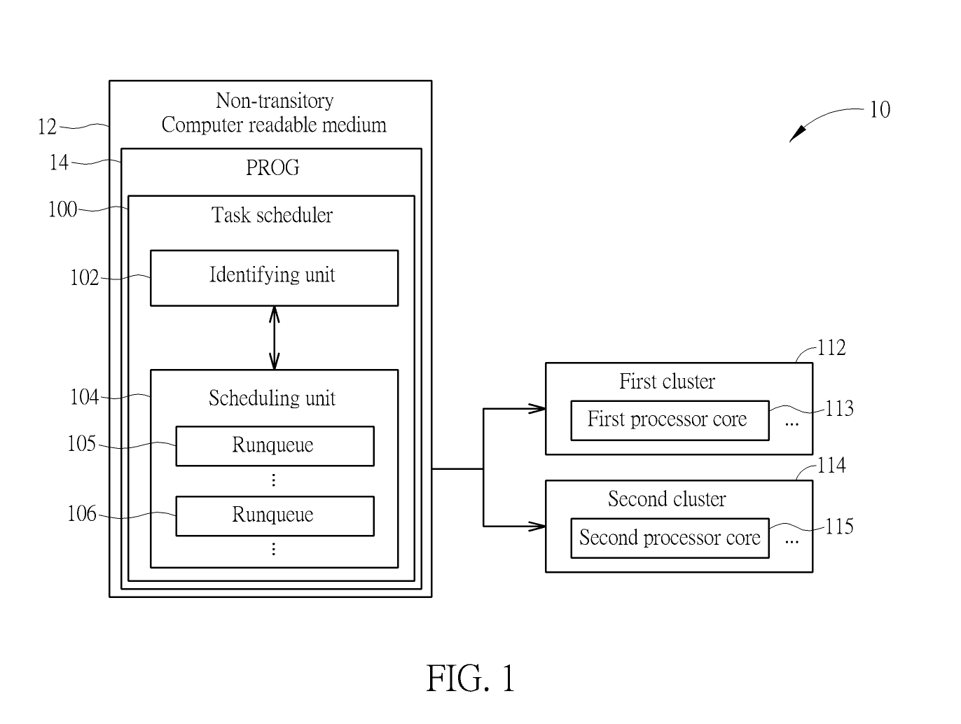

FIG. 1 is a diagram illustrating a heterogeneous multi-core system according to an embodiment of the present invention. The heterogeneous multi-core system 10 may be implemented in a portable device, such as a mobile phone, a tablet, a wearable device, etc. However, this is not meant to be a limitation of the present invention. That is, any electronic device using the proposed task scheduling method falls within the scope of the present invention. In this embodiment, the heterogeneous multi-core system 10 may have a task scheduler 100 and a plurality of clusters including a first cluster 112 and a second cluster 114. The task scheduler 100 may be coupled to the first cluster 112 and the second cluster 114, and arranged to perform the proposed task scheduling method which is used to dispatch tasks to different processor cores based on computing power of the processor cores. In this embodiment, the task scheduler 100 may be part of an operating system (OS) such as a Linux-based OS or other OS kernel supporting multiprocessor task scheduling. Hence, the task scheduler 100 may be a software module running on the heterogeneous multi-core system 10. As shown in FIG. 1, the heterogeneous multi-core system 10 may have a non-transitory computer readable medium 12 such as a memory device. The non-transitory computer readable medium 12 may store a program code (PROG) 14. When the program code 14 is loaded and executed by the heterogeneous multi-core system 10, the task scheduler 100 may perform the proposed task scheduling method which will be detailed later.

Regarding the first cluster 112 and the second cluster 114, each cluster may be a group of processor cores. That is, the first cluster 112 may include one or more first processor cores 113, each having the same first processor architecture with the same first computing power; and the second cluster 114 may include one or more second processor cores 115, each having the same second processor architecture with the same second computing power. The second processor architecture may be different from the first processor architecture, and the second computing power may be lower than the first computing power. In one embodiment, each first processor core 113 may be regarded as a performance oriented processor core, and each second processor core 115 may be regarded as a power-saving oriented processor core. It should be noted that, based on the actual design consideration, the number of first processor cores 113 included in the first cluster 112 may be identical to or different from the number of second processor cores 115 included in the second cluster 114. Therefore, the proposed task scheduling method may be applied to the heterogeneous multi-core system 10 with any combination of different processor cores.

The task scheduler 100 may include an identifying unit 102 and a scheduling unit 104. The identifying unit 102 may be configured to refer to task priorities of tasks of the heterogeneous multi-core system 10 to identify at least one first task of the tasks that belongs to a first priority task group and identify at least one second task of the tasks that belongs to a second priority task group. For example, the identifying unit 102 may be configured to compare task priorities of a plurality of tasks of the heterogeneous multi-core system 10, including task(s) currently running, task(s) waiting to run, etc., to determine which task(s) belong to the first priority task group (e.g., which task(s) should run on the first processor core(s) 113) and further determine which task(s) belong to the second priority task group (e.g., which task(s) should run on the second processor core(s) 115). The size of the first priority task group may depend on the number of first processor cores 113, and the size of the second priority task group may depend on the number of second processor cores 115. For example, the size of the first priority task group may be equal to the number of first processor cores 113, and the size of the second priority task group may be equal to the number of second processor cores 115.

The first priority task group may be treated as a highest priority task group, and the second priority task group may be treated as a next highest priority task group. Hence, each first task belonging to the first priority task group may have a task priority not lower than task priorities of other tasks not belonging to the first priority task group, and each second task belonging to the second priority task group may have a task priority not lower than task priorities of other tasks not belonging to the first priority task group and the second priority task group. In other words, any second task belonging to the second priority task group does not have a task priority higher than a task priority of any first task belonging to the first priority task group.

Based on the task identification result informed by the identifying unit 102, the scheduling unit 104 may set or adjust run queues of processor cores included in the heterogeneous multi-core system 10. Each processor core of the heterogeneous multi-core system 10 may be given a run queue managed by the scheduling unit 104. In this embodiment, one first processor core 113 in the first cluster 112 may be given a run queue 105, and one second processor core 115 in the second cluster 114 may be given a run queue 106. Hence, when there are multiple first processor cores 113, the scheduling unit 104 can manage multiple run queues 105 created for the first processor cores 113, respectively; and when there are multiple second processor cores 115, the scheduling unit 104 can manage multiple run queues 106 created for the second processor cores 115, respectively. The run queue may be a data structure which records a list of tasks, where the tasks may include a task that is currently running and other task(s) waiting to run. In some embodiments, a processor core may sequentially execute tasks included in a corresponding run queue according to task priorities of the tasks. In other words, the processor core may execute a task with higher task priority prior to executing a task with lower task priority. By way of example, but not limitation, the tasks may include programs, application program sub-components, or a combination thereof.

To reduce or avoid undesired priority inversion, the scheduling unit 104 may dispatch at least one of first task(s) belonging to the first priority task group (e.g., a highest priority task group) to at least one run queue of at least one of first processor core(s) 113 included in the first cluster 112 of the heterogeneous multi-core system 10, and/or dispatch at least one of second task(s) belonging to the second priority task group (e.g., a next highest priority task group) to at least one run queue of at least one of second processor core(s) 115 included in the second cluster 114 of the heterogeneous multi-core system 10. For better understanding of technical features of the present invention, several task scheduling operations performed by the scheduling unit 104 based the proposed task scheduling method are discussed as below.

For clarity and simplicity, the following assumes that the first cluster 112 includes two first processor cores 113 denoted by Core_{—}11 and Core_{—}12, and the second cluster 114 includes two second processor cores 115 denoted by Core_{—}21 and Core_{—}22. Hence, the scheduling unit 104 may assign two run queues 105 denoted by RQ₁₁ and RQ₁₂ to the first processor cores Core_{—}11 and Core_{—}12, respectively; and may assign two run queues 106 denoted by RQ₂₁ and RQ₂₂ for the second processor cores Core_{—}21 and Core_{—}22, respectively. The task priorities in a descending order is 0→1→2→3→4. Thus, a task with the task priority “0” is given the highest priority level among tasks executed by the heterogeneous multi-core system 10.

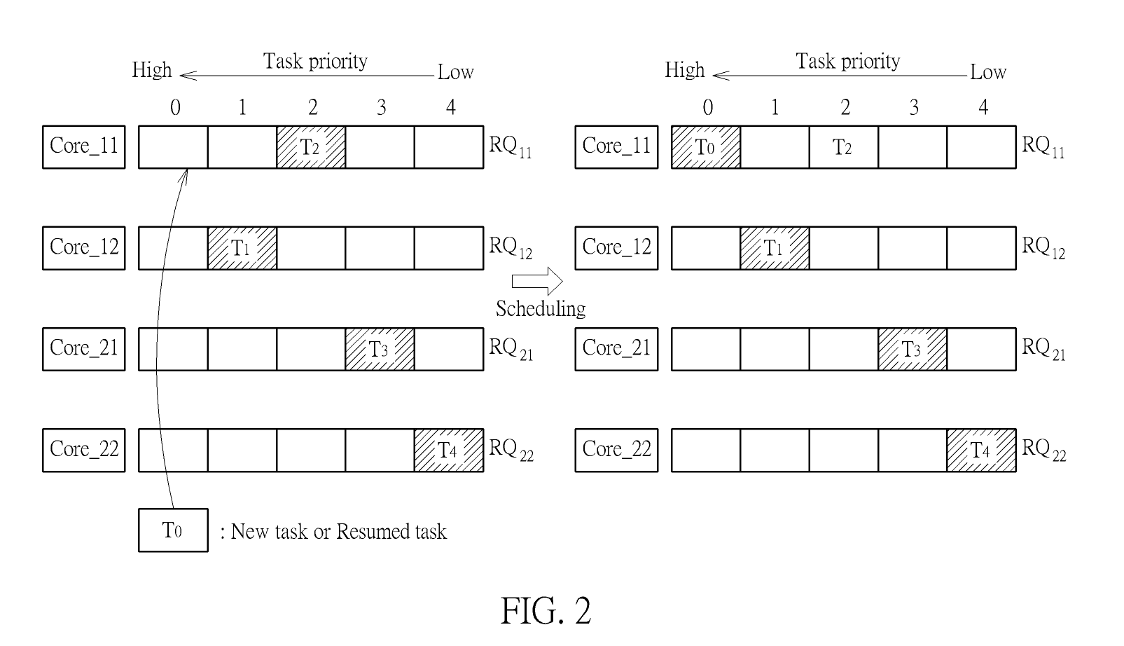

FIG. 2 is a diagram illustrating a first task scheduling operation which dispatches one first task belonging to the first priority task group to a run queue of one first processor core with higher computing power. In this example, before a task T₀ with the task priority “0” is required to be added to one of the run queues RQ₁₁, RQ₁₂, RQ₂₁, RQ₂₂ for execution, the run queue RQ₁₁ may include a task T₂ with the task priority “2” and may further include other tasks with lower task priorities (not shown in FIG. 2); the run queue RQ₁₂ may include a task T₁ with the task priority “1” and may further include other tasks with lower task priorities (not shown in FIG. 2); the run queue RQ₂₁ may include a task T₃ with the task priority “3” and may further include other tasks with lower task priorities (not shown in FIG. 2); and the run queue RQ₂₂ may include a task T₄ with the task priority “4” and may further include other tasks with lower task priorities (not shown in FIG. 2). Before the task T₀ is added to one of the run queues RQ₁₁, RQ₁₂, RQ₂₁, and RQ₂₂, a task with the highest task priority in the run queue RQ₁₁ may be the task T₂, a task with the highest task priority in the run queue RQ₁₂ may be the task T₁, a task with the highest task priority in the run queue RQ₂₁ may be the task T₃, and a task with the highest task priority in the run queue RQ₂₂ may be the task T₄. Hence, the tasks T₁, T₂, T₃, and T₄ may be currently running on the first processor core Core_{—}12, the first processor core Core_{—}11, the second processor core Core_{—}21, and the second processor core Core_{—}22, respectively.

It is possible that the system may create a new task, or a task may be added to a wait queue to wait for requested system resource(s) and then resumed when the requested system resource(s) is available. In this example, the task T₀ may be a new task or a resumed task (e.g., a wake-up task) that is not included in run queues RQ₁₁, RQ₁₂, RQ₂₁, RQ₂₂ of the heterogeneous multi-core system 10, and the scheduling unit 104 needs to select one of the run queues RQ₁₁, RQ₁₂, RQ₂₁, RQ₂₂ and then dispatch the task T₀ to the selected run queue to thereby add the task T₀ to one of the run queues RQ₁₁, RQ₁₂, RQ₂₁, RQ₂₂ for execution.

As mentioned above, the identifying unit 102 may be configured to perform task identification to determine the first priority task group (e.g., a highest priority task group) and the second priority task group (e.g., a next highest priority task group), where the size of the first priority task group may depend on the number of first processor cores with the first computing power, and the size of the second priority task group may depend on the number of second processor cores with the second computing power lower than the first computing power. In this example, there are two first processor cores Core_{—}11 and Core_{—}12 and two second processor cores Core_{—}21 and Core_{—}22. Consider a case where the size of the first priority task group is set to be equal to the number of first processor cores, and the size of the second priority task group is set to be equal to the number of second processor cores. Hence, because task priorities of two tasks T₀ and T₁ are not lower than task priorities of other tasks T₂, T₃ and T₄, and task priorities of two tasks T₂ and T₃ are not higher than task priorities of tasks T₀ and T₁ and not lower than task priorities of other tasks (e.g., T₄), the identifying unit 102 may identify tasks T₀ and T₁ as tasks belonging to the first priority task group, and may identify tasks T₂ and T₃ as tasks belonging to the second priority task group. The task T₀ to be scheduled has the task priority “0” higher than task priorities “1” and “2” of tasks T₁ and T₂ currently running on the first processor cores Core_{—}12 and Core_{—}11 with higher computing power. Hence, the scheduling unit 104 may push the task T₀ (which is identified as a task belonging to the first priority task group) into one of the run queues RQ₁₁ and RQ₁₂ to reduce or avoid undesired priority inversion.

The scheduling unit 104 may select a specific run queue from run queues RQ₁₁ and RQ₁₂ of the first processor cores Core_{—}11 and Core_{—}12, and then add the task T₀ to the specific run queue. In one exemplary design, the highest task priority possessed by one task in the specific run queue is a lowest one of the highest task priorities possessed by tasks in the run queues RQ₁₁ and RQ₁₂. In this example, since the highest task priority “2” possessed by the task T₂ in the run queue RQ₁₁ is lower than the highest task priority “1” possessed by the task T₁ in the run queue RQ₁₂, the scheduling unit 104 may select the run queue RQ₁₁ as the specific run queue to which the task T₀ will be added.

After the task scheduling of the task T₀ is accomplished/terminated, the run queue RQ₁₁ may include at least the tasks T₀ and T₂, the run queue RQ₁₂ may include at least the task T₁, the run queue RQ₂₁ may include at least the task T₃, and the run queue RQ₂₂ may include at least the task T₄. By way of example, but not limitation, the scheduling unit 104 may further ensure that each first task belonging to the first priority task group is included in a run queue of one first processor core. As shown in FIG. 2, all of the tasks T₀ and T₁ belonging to the first priority task group are included in run queues RQ₁₁ and RQ₁₂ of the first processor cores Core_{—}11 and Core_{—}12.

It should be noted that the task priority “0” of the task T₀ is higher than the task priority “2” of the task T₂. Hence, after the task T₀ is added to the run queue RQ₁₁, the task T₀ may become a task currently running on the first processor core Core_{—}11, and the task T₂ may become a task waiting to run on the first processor core Core_{—}11.

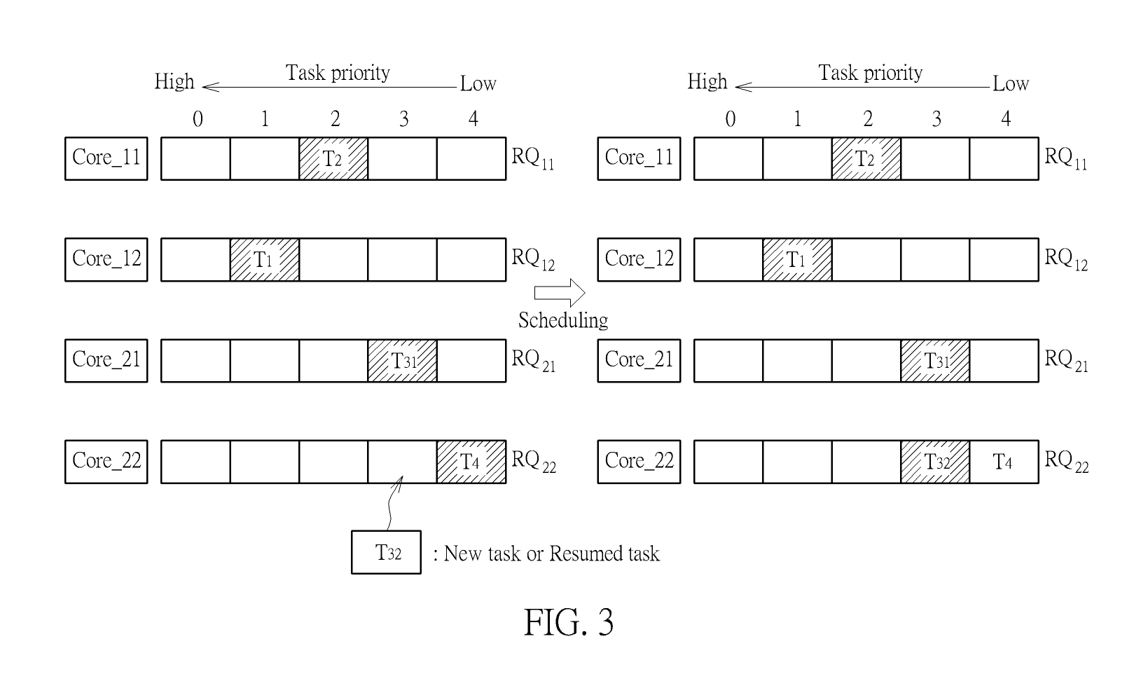

FIG. 3 is a diagram illustrating a second task scheduling operation which dispatches one second task belonging to the second priority task group to a run queue of one second processor core with lower computing power. In this example, before a task T₃₂ with the task priority “3” is required to be added to one of the run queues RQ₁₁, RQ₁₂, RQ₂₁, RQ₂₂ for execution, the run queue RQ₁₁ may include a task T₂ with the task priority “2” and may further include other tasks with lower task priorities (not shown in FIG. 3); the run queue RQ₁₂ may include a task T₁ with the task priority “1” and may further include other tasks with lower task priorities (not shown in FIG. 3); the run queue RQ₂₁ may include a task T₃₁ with the task priority “3” and may further include other tasks with lower task priorities (not shown in FIG. 3); and the run queue RQ₂₂ may include a task T₄ with the task priority “4” and may further include other tasks with lower task priorities (not shown in FIG. 3). A task with the highest task priority in the run queue RQ₁₁ may be the task T₂, a task with the highest task priority in the run queue RQ₁₂ may be the task T₁, a task with the highest task priority in the run queue RQ₂₁ may be the task T₃₁, and a task with the highest task priority in the run queue RQ₂₂ may be the task T₄. Hence, the tasks T₁, T₂, T₃₁, and T₄ may be currently running on the first processor core Core_{—}12, the first processor core Core_{—}11, the second processor core Core_{—}21, and the second processor core Core_{—}22, respectively.

As mentioned above, it is possible that the system may create a new task, or a task may be added to a wait queue to wait for requested system resource(s) and then resumed when the requested system resource(s) is available. In this example, the task T₃₂ may be a new task or a resumed task (e.g., a wake-up task) that is not included in run queues RQ₁₁, RQ₁₂, RQ₂₁, RQ₂₂ of the heterogeneous multi-core system 10, and the scheduling unit 104 may need to select one of the run queues RQ₁₁, RQ₁₂, RQ₂₁, RQ₂₂ and then dispatch the task T₃₂ to the selected run queue to thereby add the task T₃₂ to one of the run queues RQ₁₁, RQ₁₂, RQ₂₁, RQ₂₂ for execution.

In this example, there are two first processor cores Core_{—}11 and Core_{—}12 and two second processor cores Core_{—}21 and Core_{—}22. Consider a case where the size of the first priority task group is set to be equal to the number of first processor cores, and the size of the second priority task group is set to be equal to the number of second processor cores. Hence, because task priorities of two tasks T₁ and T₂ are not lower than task priorities of other tasks (e.g., T₃₁, T₃₂ and T₄), and task priorities of two tasks T₃₁ and T₃₂ are not higher than task priorities of the tasks T₁ and T₂ and not lower than task priorities of other tasks (e.g., T₄), the identifying unit 102 may identify tasks T₁ and T₂ as tasks belonging to the first priority task group, and may identify tasks T₃₁ and T₃₂ as tasks belonging to the second priority task group.

The task T₃₂ to be scheduled has the task priority “3” lower than task priorities “1” and “2” of tasks T₁ and T₂, where the tasks T₁ and T₂ are identified as tasks belonging to the first priority task group and currently running on the first processor cores Core_{—}12 and Core_{—}11 with higher computing power. Hence, the scheduling unit 104 may push the task T₃₂ (which is identified as a task belonging to the second priority task group) into one of the run queues RQ₂₁ and RQ₂₂ to reduce or avoid undesired priority inversion.

The scheduling unit 104 may select a specific run queue from run queues RQ₂₁ and RQ₂₂ of the second processor cores Core_{—}21 and Core_{—}22, and add the task T₃₂ to the specific run queue. For example, the highest task priority possessed by one task in the specific run queue may have a lowest one of the highest task priorities possessed by tasks in the run queues RQ₂₁ and RQ₂₂. Since the highest task priority “4” possessed by the task T₄ in the run queue RQ₂₂ is lower than the highest task priority “3” possessed by the task T₃₁ in the run queue RQ₂₁, the scheduling unit 104 may select the run queue RQ₂₂ as the specific run queue to which the task T₃₂ will be added.

After the task scheduling of the task T₃₂ is accomplished/terminated, the run queue RQ₁₁ may include at least the task T₂, the run queue RQ₁₂ may include at least the task T₁, the run queue RQ₂₁ may include at least the task T₃₁, and the run queue RQ₂₂ may include at least the tasks T₃₂ and T₄. It should be noted that the task priority “3” of the task T₃₂ is higher than the task priority “4” of the task T₄. Hence, after the task T₃₂ is added to the run queue RQ₂₂, the task T₃₂ may become a task currently running on the second processor core Core_{—}22, and the task T₄ may become a task waiting to run on the second processor core Core_{—}22.

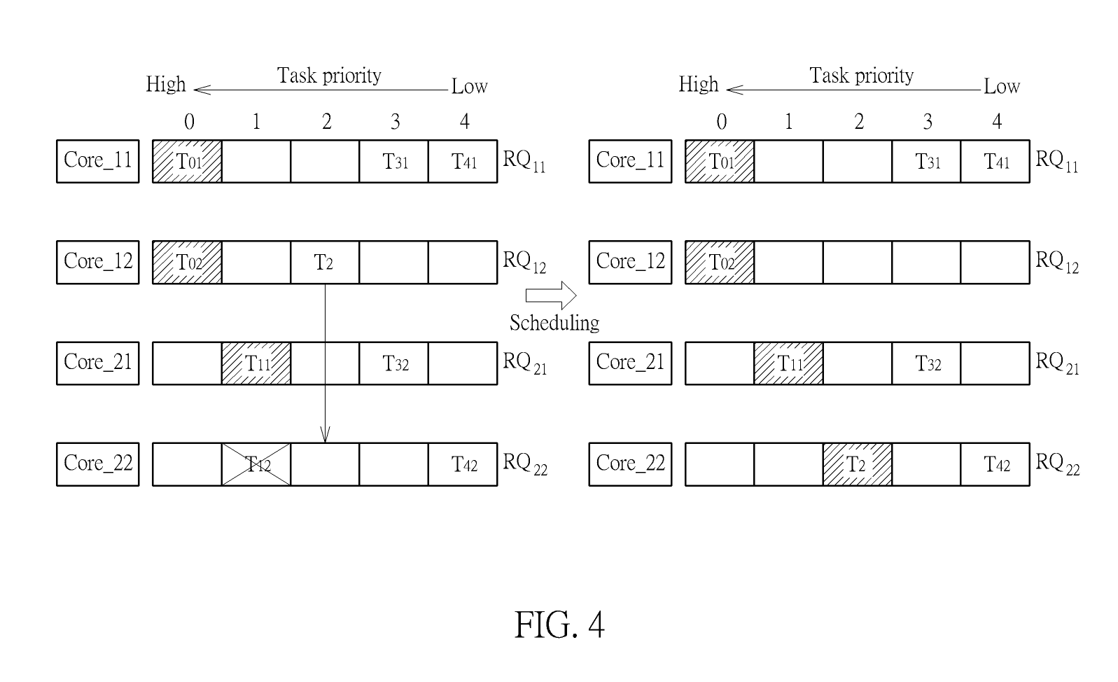

FIG. 4 is a diagram illustrating a third task scheduling operation which dispatches one second task belonging to the second priority task group to a run queue of one second processor core with lower computing power. In this example, before a task T₁₂ with the task priority “1” is removed from the run queue RQ₂₂, the run queue RQ₁₁ may include a task T₀₁ with the task priority “0” and may further include other tasks with lower task priorities (e.g., a task T₃₁ with the task priority “3” and a task T₄₁ with the task priority “4”); the run queue RQ₁₂ may include a task T₀₂ with the task priority “0” and may further include other tasks with lower task priorities (e.g., a task T₂ with the task priority “2”); the run queue RQ₂₁ may include a task T₁₁ with the task priority “1” and may further include other tasks with lower task priorities (e.g., a task T₃₂ with the task priority “3”); and the run queue RQ₂₂ may include the task T₁₂ with the task priority “1” and may further include other tasks with lower task priorities (e.g., a task T₄₂ with the task priority “4”). Before removal of the task T₁₂ in the run queue RQ₂₂ occurs, a task with the highest task priority in the run queue RQ₁₁ may be the task T₀₁, a task with the highest task priority in the run queue RQ₁₂ may be the task T₀₂, a task with the highest task priority in the run queue RQ₂₁ may be the task T₁₁, and a task with the highest task priority in the run queue RQ₂₂ may be the task T₁₂. Hence, before removal of the task T₁₂ in the run queue RQ₂₂ occurs, the tasks T₀₁, T₀₂, T₁₁, and T₁₂ may be currently running on the first processor core Core_{—}11, the first processor core Core_{—}12, the second processor core Core_{—}21, and the second processor core Core_{—}22, respectively.

In a case where the execution of the task T₁₂ is accomplished/terminated by the second processor core Core_{—}22 (i.e., the second processor core Core_{—}22 is at a schedule point), the scheduling unit 104 may remove the accomplished/terminated task T₁₂ from the run queue RQ₂₂ due to that the task T₁₂ is a terminated task now. In another case where the system resource(s) requested by the task T₁₂ currently running on the second processor core Core_{—}22 is not available yet, the execution of the task T₁₂ may be stopped, and the scheduling unit 104 may remove the task T₁₂ from the run queue RQ₂₂ and add the task T₁₂ to a wait queue since the task T₁₂ needs to wait for the requested system resource(s). In either of these cases, the scheduling unit 104 may pull a task that is identified as a task belonging to the second priority task group and included in a run queue of one of the first processor cores Core_{—}11 and Core_{—}12 and the second processor cores Core_{—}21 and Core_{—}22 to the run queue RQ₂₂ in response to removal of the task T₁₂ having the highest task priority in the run queue RQ₂₂.

As mentioned above, the identifying unit 102 may be configured to perform task identification to determine the first priority task group (e.g., a highest priority task group) and the second priority task group (e.g., a next highest priority task group), where the size of the first priority task group may depend on the number of first processor cores with the first computing power, and the size of the second priority task group may depend on the number of second processor cores with the second computing power lower than the first computing power. In this example, there are two first processor cores Core_{—}11 and Core_{—}12 and two second processor cores Core_{—}21 and Core_{—}22. Consider a case where the size of the first priority task group is set to be equal to the number of first processor cores, and the size of the second priority task group is set to be equal to the number of second processor cores. After the task T₁₂ is removed from the run queue RQ₂₂, task priorities of two tasks T₀₁ and T₀₂ are not lower than task priorities of other tasks (e.g., T₁₁, T₂, T₃₁, T₃₂, T₄₁, and T₄₂), and task priorities of two tasks T₁₁ and T₂ are not higher than task priorities of tasks T₀₁ and T₀₂ and not lower than task priorities of other tasks (e.g., T₃₁, T₃₂, T₄₁ and T₄₂). Hence, the identifying unit 102 may identify tasks T₀₁ and T₀₂ as tasks belonging to the first priority task group, and may identify tasks T₁₁ and T₂ as tasks belonging to the second priority task group.

After the task T₁₂ is removed from the run queue RQ₂₂, the task T₄₂ waiting to run on the second processor core Core_{—}22 becomes a task with the highest task priority in the run queue RQ₂₂. The task priorities of tasks T₁₁ and T₂ belonging to the second priority task group are higher than the task priority of the task T₄₂, where the task T₂ belonging to the second priority task group is included in the run queue RQ₁₂ of the first processor core Core_{—}12. Hence, the scheduling unit 104 may pull the task T₂ from the run queue RQ₁₂ to the run queue RQ₂₂ to reduce or avoid undesired priority inversion. For example, after the task T₁₂ is removed from the run queue RQ₂₂, the scheduling unit 104 may pull the task T₂ belonging to the second priority task group from the run queue RQ₁₂ of the first processor core Core_{—}12 to the run queue RQ₂₂ of the second processor core Core_{—}22 when the task T₂ has the task priority that is the next highest task priority possessed by the run queue RQ₁₂ (i.e., the task T₂ in the run queue RQ₁₂ is a task waiting to run on the first processor core Core_{—}12). For another example, after the task T₁₂ is removed from the run queue RQ₂₂, the scheduling unit 104 may pull the task T₂ belonging to the second priority task group from the run queue RQ₁₂ of the first processor core Core_{—}12 to the run queue RQ₂₂ of the second processor core Core_{—}22 when the task T₂ has the task priority that is next to the task priority of the removed task T₁₂. For yet another example, after the task T₁₂ is removed from the run queue RQ₂₂, the scheduling unit 104 may pull the task T₂ belonging to the second priority task group from the run queue RQ₁₂ of the first processor core Core_{—}12 to the run queue RQ₂₂ of the second processor core Core_{—}22 when the task T₂ has the task priority that is higher than the highest task priority possessed by one task (e.g., T₄₂) in the run queue RQ₂₂ that is waiting to run.

After the task scheduling of the task T₂ is accomplished/terminated, the run queue RQ₁₁ may include at least the tasks T₀₁, T₃₁, and T₄₁, the run queue RQ₁₂ may include at least the task T₀₂, the run queue RQ₂₁ may include at least the tasks T₁₁ and T₃₂, and the run queue RQ₂₂ may include at least the tasks T₂ and T₄₂. It should be noted that the task priority “2” of the task T₂ is higher than the task priority “4” of the task T₄₂. Hence, after the task T₂ is pulled from the run queue RQ₁₂ to the run queue RQ₂₂, the task T₂ may become a task currently running on the second processor core Core_{—}22, and the task T₄₂ is still a task waiting to run on the second processor core Core_{—}22.

In above example in FIG. 4, the task T₂ is pulled from the run queue RQ₁₂ to the run queue RQ₂₂. However, this is for illustrative purposes only, and is not meant to be a limitation of the present invention. In another case, the same task scheduling policy mentioned above may be followed to pull the task T₂ with the task priority “2” from a different run queue to the run queue RQ₂₂ with the task T12 removed therefrom. For example, when the task T₂ with the task priority “2” is included in the run queue RQ₁₁ rather than the run queue RQ₁₂, the task T₂ belonging to the second priority task group may be pulled from the run queue RQ₁₁ to the run queue RQ₂₂ after the task T₁₂ is removed from the run queue RQ₂₂. For another example, when the task T₂ with the task priority “2” is included in the run queue RQ₂₁ rather than the run queue RQ₁₂, the task T₂ belonging to the second priority task group may be pulled from the run queue RQ₂₁ to the run queue RQ₂₂ after the task T₁₂ is removed from the run queue RQ₂₂.

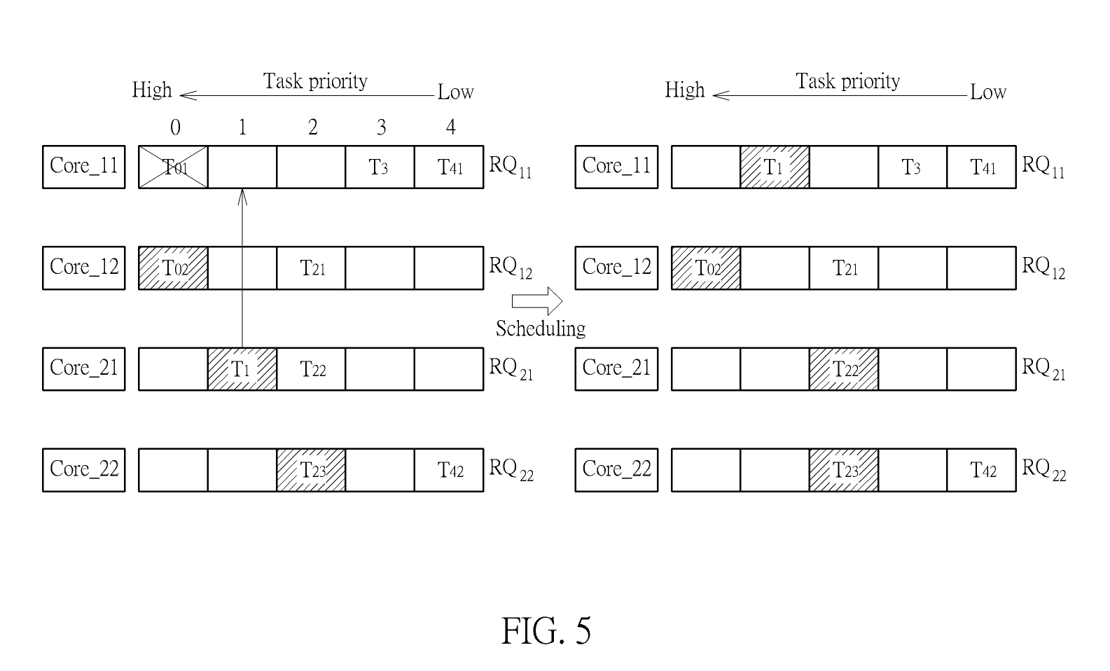

FIG. 5 is a diagram illustrating a fourth task scheduling operation which dispatches one first task belonging to the first priority task group to a run queue of one first processor core with higher computing power. In this example, before a task T₀₁ with the task priority “0” is removed from the run queue RQ₁₁, the run queue RQ₁₁ may include a task T₀₁ with the task priority “0” and may further include other tasks with lower task priorities (e.g., a task T₃ with the task priority “3” and a task T₄₁ with the task priority “4”); the run queue RQ₁₂ may include a task T₀₂ with the task priority “0” and may further include other tasks with lower task priorities (e.g., a task T₂₁ with the task priority “2”); the run queue RQ₂₁ may include a task T₁ with the task priority “1” and may further include other tasks with lower task priorities (e.g., a task T₂₂ with the task priority “2”); and the run queue RQ₂₂ may include a task T₂₃ with the task priority “2” and may further include other tasks with lower task priorities (e.g., a task T₄₂ with the task priority “4”). Before removal of the task T₀₁ in the run queue RQ₁₁ occurs, a task with the highest task priority in the run queue RQ₁₁ may be the task T₀₁, a task with the highest task priority in the run queue RQ₁₂ may be the task T₀₂, a task with the highest task priority in the run queue RQ₂₁ may be the task T₁, and a task with the highest task priority in the run queue RQ₂₂ may be the task T₂₃. In addition, before removal of the task T₀₁ in the run queue RQ₁₁ occurs, the tasks T₀₁, T₀₂, T₁, and T₂₃ may be currently running on the first processor core Core_{—}11, the first processor core Core_{—}12, the second processor core Core_{—}21, and the second processor core Core_{—}22, respectively.

As mentioned above, a task may be removed from a run queue when execution of the task is accomplished/terminated or system resource(s) requested by the task is not available yet. In this example, the scheduling unit 104 may remove the task T₀₁ from the run queue RQ₁₁ due to any of above reasons. In addition, the scheduling unit 104 may pull a task that is identified as a task belonging to the first priority task group and included in a run queue of one of the second processor cores Core_{—}21 and Core_{—}22 and the first processor core Core_{—}12 to the run queue RQ₁₁ in response to removal of the task T₀₁ having the highest task priority in the run queue RQ₁₁. Alternatively, the task T₁ may be a task waiting to run on the first processor core Core_{—}11 at the time the task T₀₁ is removed from the run queue RQ₁₁. This also falls within the scope of the present invention.

There are two first processor cores Core_{—}11 and Core_{—}12 and two second processor cores Core_{—}21 and Core_{—}22. Consider a case where the size of the first priority task group is set to be equal to the number of first processor cores, and the size of the second priority task group is set to be equal to the number of second processor cores. After the task T₀₁ is removed from the run queue RQ₁₁, task priorities of two tasks T₀₂ and T₁ are not lower than task priorities of other tasks (e.g., T₂₁, T₂₂, T₂₃, T₃, T₄₁, and T₄₂), and task priorities of two tasks T₂₂ and T₂₃ are not higher than task priorities of tasks T₀₂ and T₁ and not lower than task priorities of other tasks (e.g., T₂₁, T₃, T₄₁ and T₄₂). Hence, the identifying unit 102 may identify tasks T₀₂ and T₁ as tasks belonging to the first priority task group, and may identify tasks T₂₂ and T₂₃ as tasks belonging to the second priority task group. It should be noted that identifying the tasks T₂₂ and T₂₃ as tasks belonging to the second priority task group is for illustrative purposes only. For example, any two of the tasks T₂₁, T₂₂ and T₂₃ having the same task priority “2” may be identified as tasks belonging to the second priority task group.

After the task T₀₁ is removed from the run queue RQ₁₁, the task T₃ waiting to run on the first processor core Core_{—}11 becomes a task with the highest task priority in the run queue RQ₁₁. The task priorities of tasks T₀₂ and T₁ belonging to the first priority task group are higher than the task priority of the task T₃, where the task T₁ belonging to the first priority task group is included in the run queue RQ₂₁ of the second processor core Core_{—}21. Hence, the scheduling unit 104 may instruct the run queue RQ₂₁ to release the task T₁ currently running on the second processor core Core_{—}21, and grant the task T₂₂ in the run queue RQ₂₁ to be selected for running on the second processor core Core_{—}21. And the scheduling unit 104 may pull the released task T₁ from the run queue RQ₂₁ to the run queue RQ₁₁ to reduce or avoid undesired priority inversion. For example, the scheduling unit 104 may pull the task T₁ belonging to the first priority task group from the run queue RQ₂₁ of the second processor core Core_{—}21 to the run queue RQ₁₁ of the first processor core Core_{—}11 when the highest task priority possessed by one task (e.g., T₁) in the run queue RQ₂₁ is the highest one of highest task priorities possessed by tasks (e.g., T₁ and T₂₃) in run queues of the second processor cores Core_{—}21 and Core_{—}22 and the task (e.g., T₁) with the highest task priority in the run queue RQ₂₁ has a task priority higher than the highest task priority possessed by one task (e.g., T₃) in the run queue RQ₁₁ that is waiting to run. For another example, the scheduling unit 104 may pull the task T₁ belonging to the first priority task group from the run queue RQ₂₁ of the second processor core Core_{—}21 to the run queue RQ₁₁ of the first processor core Core_{—}11 when the task T₁ has the task priority that is next to the task priority of the removed task T₀₁ and higher than the highest task priority possessed by one task (e.g., T₃) in the run queue RQ₁₁ that is waiting to run.

After the task scheduling of the task T₁ is accomplished/terminated, the run queue RQ₁₁ may include at least the tasks T₁, T₃ and T₄₁, the run queue RQ₁₂ may include at least the tasks T₀₂ and T₂₁, the run queue RQ₂₁ may include at least the task T₂₂, and the run queue RQ₂₂ may include at least the tasks T₂₃ and T₄₂. In this example, the scheduling unit 104 may further ensure that each first task belonging to the first priority task group is included in a run queue of one first processor core. As shown in FIG. 5, all of the tasks T₁ and T₀₂ belonging to the first priority task group are included in run queues RQ₁₁ and RQ₁₂ of the first processor cores Core_{—}11 and Core_{—}12.

It should be noted that the task priority “1” of the task T₁ is higher than the task priority “3” of the task T₃. Hence, after the task T₁ is pulled from the run queue RQ₂₁ to the run queue RQ₁₁, the task T₁ becomes a task currently running on the first processor core Core_{—}11, and the task T₃ is still a task waiting to run on the first processor core Core_{—}11.

All tasks to be executed on the heterogeneous multi-core 10 may be divided into real-time tasks and normal tasks based on the task priorities. Compared to the normal tasks, the real-time tasks have higher task priorities. For example, each of the real-time tasks may be given a task priority falling within a first priority range such as [0, 99], and each of the normal tasks may be given a task priority falling within a second priority range such as [100, 139]. In above embodiments, the proposed task scheduling method performed by the task scheduler 100 may be used for real-time task scheduling. Hence, the tasks scheduled using the proposed task scheduling method may be real-time tasks only. However, this is not meant to be a limitation of the present invention. In an alternative design, the proposed task scheduling method performed by the task scheduler 100 may be used for normal task scheduling. Hence, the tasks scheduled using the proposed task scheduling method may be normal tasks only. In another alternative design, the tasks scheduled using the proposed task scheduling method may include real-time task(s) and normal task(s). To put it simply, any task scheduler of an OS kernel that uses the proposed task scheduling method falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A task scheduling method for a heterogeneous multi-core system, the heterogeneous multi-core system including at least one first processor core each having first computing power and at least one second processor core each having second computing power lower than the first computing power, the task scheduling method comprising:
referring to task priorities of tasks of the heterogeneous multi-core system to identify at least one first task of the tasks that belongs to a first priority task group, wherein each first task belonging to the first priority task group has a task priority not lower than task priorities of other tasks not belonging to the first priority task group; and
dispatching at least one of the at least one first task to at least one run queue of at least one of the at least one first processor core.

2. The task scheduling method of claim 1, wherein the task scheduling method ensures that each of the at least one first task is included in a run queue of one of the at least one first processor core.

3. The task scheduling method of claim 1, wherein at least one of the at least one first task that is to be dispatched is a specific task that is not included in run queues of the heterogeneous multi-core system.

4. The task scheduling method of claim 3, wherein the step of dispatching at least one of the at least one first task comprises:
selecting a specific run queue from the at least one run queue of the at least one first processor core, wherein a highest task priority possessed by one task in the specific run queue is a lowest one of any highest task priority possessed by tasks in the at least one run queue of the at least one first processor core; and
adding the specific task to the specific run queue.

5. The task scheduling method of claim 1, wherein at least one of the at least one first task that is to be dispatched is a specific task included in a specific run queue of one of the at least one second processor core.

6. The task scheduling method of claim 5, wherein the specific task in the specific run queue has a task priority higher than a highest task priority possessed by one task in another specific run queue of one of the at least one first processor core; and the step of dispatching at least one of the at least one first task comprises:
pulling the specific task from the specific run queue of one of the at least one second processor core to the another specific run queue of one of the at least one first processor core.

7. The task scheduling method of claim 6, wherein before the pulling step is performed, a highest task priority possessed by one task in the specific run queue is a highest one of any highest task priority possessed by tasks in the at least one run queue of the at least one second processor core.

8. The task scheduling method of claim 1, wherein a size of the first priority task group depends on a number of the at least one first processor core.

9. The task scheduling method of claim 1, wherein at least one of the tasks is a real-time task.

10. A task scheduling method for a heterogeneous multi-core system, the heterogeneous multi-core system including at least one first processor core each having first computing power and at least one second processor core each having second computing power lower than the first computing power, the task scheduling method comprising:
referring to task priorities of tasks of the heterogeneous multi-core system to identify at least one first task of the tasks that belongs to a first priority task group and identify at least one second task of the tasks that belongs to a second priority task group, wherein each first task belonging to the first priority task group has a task priority not lower than task priorities of other tasks not belonging to the first priority task group, each second task belonging to the second priority task group has a task priority not lower than task priorities of other tasks not belonging to the first priority task group and the second priority task group; and
dispatching at least one of the at least one second task to at least one run queue of at least one of the at least one second processor core.

11. The task scheduling method of claim 10, wherein at least one of the at least one second task that is to be dispatched is a specific task that is not included in run queues of the heterogeneous multi-core system.

12. The task scheduling method of claim 11, wherein the step of dispatching at least one of the at least one second task comprises:
selecting a specific run queue from the at least one run queue of the at least one second processor core, wherein a highest task priority possessed by one task in the specific run queue has a lowest one of any highest task priority possessed by tasks in the at least one run queue of the at least one second processor core; and
adding the specific task to the specific run queue.

13. The task scheduling method of claim 10, wherein at least one of the at least one second task that is to be dispatched is a specific task included in a specific run queue of one of the at least one first processor core and the at least one second processor core.

14. The task scheduling method of claim 13, wherein the specific task has a task priority higher than a highest task priority possessed by one task in another specific run queue of one of the at least one second processor core; and the step of dispatching at least one of the at least one second task comprises:
pulling the specific task from the specific run queue to the another specific run queue.

15. The task scheduling method of claim 14, wherein in the specific run queue, the specific task has the task priority that is a next highest task priority.

16. The task scheduling method of claim 10, wherein a size of the first priority task group depends on a number of the at least one first processor core, a size of the second priority task group depends on a number of the at least one second processor core.

17. The task scheduling method of claim 10, wherein at least one of the tasks is a real-time task.

18. A non-transitory computer readable medium storing a program code that, when executed by a heterogeneous multi-core system including at least one first processor core each having first computing power and at least one second processor core each having second computing power lower than the first computing power, causes the heterogeneous multi-core system to perform following steps:
referring to task priorities of tasks of the heterogeneous multi-core system to identify at least one first task of the tasks that belongs to a first priority task group, wherein each first task belonging to the first priority task group has a task priority not lower than task priorities of other tasks not belonging to the first priority task group; and
dispatching at least one of the at least one first task to at least one run queue of at least one of the at least one first processor core.

19. The non-transitory computer readable medium of claim 18, wherein each of the at least one first task is ensured to be included in a run queue of one of the at least one first processor core.

20. The non-transitory computer readable medium of claim 18, wherein at least one of the tasks is a real-time task.

21. The non-transitory computer readable medium of claim 18, wherein a size of the first priority task group depends on a number of the at least one first processor core.

22. A non-transitory computer readable medium storing a program code that, when executed by a heterogeneous multi-core system including at least one first processor core each having first computing power and at least one second processor core each having second computing power lower than the first computing power, causes the heterogeneous multi-core system to perform following steps:
referring to task priorities of tasks of the heterogeneous multi-core system to identify at least one first task of the tasks that belongs to a first priority task group and identify at least one second task of the tasks that belongs to a second priority task group, wherein each first task belonging to the first priority task group has a task priority not lower than task priorities of other tasks not belonging to the first priority task group, each second task belonging to the second priority task group has a task priority not lower than task priorities of other tasks not belonging to the first priority task group and the second priority task group; and
dispatching at least one of the at least one second task to at least one run queue of at least one of the at least one second processor core.

23. The non-transitory computer readable medium of claim 22, wherein at least one of the tasks is a real-time task.

24. The non-transitory computer readable medium of claim 22, wherein a size of the first priority task group depends on a number of the at least one first processor core, and a size of the second priority task group depends on a number of the at least one second processor core.
